(19) United States
(12) Patent Application Publication
(10) Pub. No.: US 2026/0269157 A1
(43) Pub. Date: Sep. 10, 2026

(54) ELECTRICAL OPERATING DEVICE

(71) Applicant: KAWASAKI JUKOGYO KABUSHIKI KAISHA, Kobe-shi, Hyogo (JP)

(72) Inventors: Takanori YASUNAGA, Kobe-shi (JP); Hiroaki SHIMIZU, Kobe-shi (JP)

(73) Assignee: KAWASAKI JUKOGYO KABUSHIKI KAISHA, Kobe-shi, Hyogo (JP)

(21) Appl. No.: 19/166,130

(22) PCT Filed: Nov. 29, 2023
(86) PCT No.: PCT/JP2023/042700

§ 371 Date: Sep. 17, 2025

(30) Foreign Application Priority Data
Mar. 24, 2023 (JP) 2023-048164

(51) Int. Cl. H01H 19/60; H01C 10/50; H01H 19/04; H01H 19/08; H01H 19/14

(52) U.S. Cl. CPC H01H 19/60; H01C 10/50; H01H 19/04; H01H 19/08; H01H 19/14

(57) ABSTRACT

An electrical operating device includes: a casing; a cam shaft rotatably supported by the casing; a cam, which rotates together with the cam shaft; a potentiometer, which detects a rotational angle of the cam shaft; and a potentiometer cover. The potentiometer cover includes: a holder that holds the potentiometer, mounting portions mounted to the casing; and urging portions that are located between the holder and the mounting portions and that cause the potentiometer to be in contact with the casing.

### TECHNICAL FIELD

The present disclosure relates to an electrical operating device.

### BACKGROUND ART

Patent Literature 1 discloses an electronic operating device. This operating device is used to operate a construction machine. In this operating device, a cam is rotatably supported by a support base. The cam includes a mounting portion that accommodates a magnet therein. By means of the magnet and a magnetosensitive sensor, the position of the cam is detected.

The construction machine is operated based on the detected position of the cam.

### CITATION LIST

### Patent Literature

PTL 1: Japanese Laid-Open Patent Application Publication No. 2018-10635

### SUMMARY OF INVENTION

### Technical Problem

In the electronic operating device of Patent Literature 1, the magnetosensitive sensor is positioned near the cam. On the other hand, it is conceivable to detect the position of the cam from the amount of rotation of the cam shaft. Specifically, the position of the cam can be detected by detecting, with a potentiometer, the amount of rotation of the cam shaft.

FIG. 8 shows an example of a structure in which the amount of rotation of a cam shaft 102 is detected with a potentiometer 101. In FIG. 8, the cam shaft 102 is rotatably supported by a support base 103. A holder 104 is fitted to the support base 103, and is thereby positioned. A spring 105 urges a cover 106. The urged cover 106 presses the potentiometer 101 against the holder 104. As a result of the potentiometer 101 being pressed by the cover 106 against the holder 104, the potentiometer 101 is positioned. In this manner, the potentiometer 101 is positioned on the support base 103 while absorbing dimensional variations in the potentiometer 101. The potentiometer 101 includes a rotating shaft that is coupled to the cam shaft 102 via a coupling 107.

In the structure of FIG. 8, a cam that is not shown is fixed to the cam shaft 102. The potentiometer 101 detects the amount of rotation of the cam shaft 102. As a result, the position of the cam is detected. In the case of this structure, the potentiometer 101 can be mounted or removed in a state where the cam is mounted to the support base 103.

However, the structure shown in FIG. 8 uses the holder 104, the spring 105, and the cover 106 for mounting the potentiometer 101. That is, adopting this structure results in an increase in the number of components. An increase in the number of components results in an increase in assembly man-hours. In an electrical operating device in which the potentiometer 101 is used, a reduction in the number of components is desired.

It is an intention of the applicant of the present application to provide an electrical operating device that makes it possible to reduce the number of components therein.

### Solution to Problem

An electrical operating device disclosed in the present disclosure includes: a casing; a cam shaft rotatably supported by the casing; a cam that rotates together with the cam shaft; a potentiometer that detects a rotational angle of the cam shaft; and a potentiometer cover including: a holder that holds the potentiometer; mounting portions mounted to the casing; and urging portions that are located between the holder and the mounting portions and that cause the potentiometer to be in contact with the casing.

### Advantageous Effects of Invention

The above-described electrical operating device makes it possible to reduce the number of components therein.

### BRIEF DESCRIPTION OF DRAWINGS

FIG. 1 is a perspective view of an electrical operating device according to one embodiment.

FIG. 2 is a partial sectional perspective view of the electrical operating device of FIG. 1.

FIG. 3 is a perspective view of a potentiometer and a potentiometer cover of the electrical operating device of FIG. 1.

FIG. 4 is a front view of the potentiometer cover of FIG. 3.

FIG. 5 illustrates a mounted state of the potentiometer as indicated by reference sign V in FIG. 2.

FIG. 6 illustrates a usage state of the electrical operating device of FIG. 1, in which a cam is in a neutral position.

FIG. 7 illustrates a usage state of the electrical operating device of FIG. 1, in which the cam is in a rotated position.

FIG. 8 illustrates a potentiometer mounting structure as a comparative example to be compared with the electrical operating device of FIG. 1.

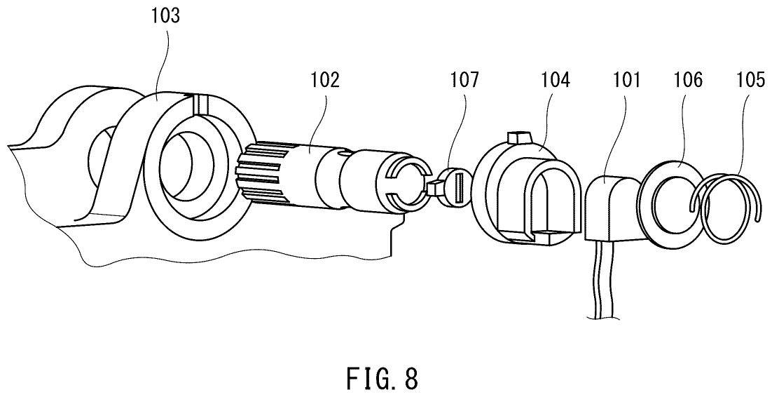

### DESCRIPTION OF EMBODIMENTS

Hereinafter, preferred embodiments are described in detail with reference to the accompanying drawings as necessary.

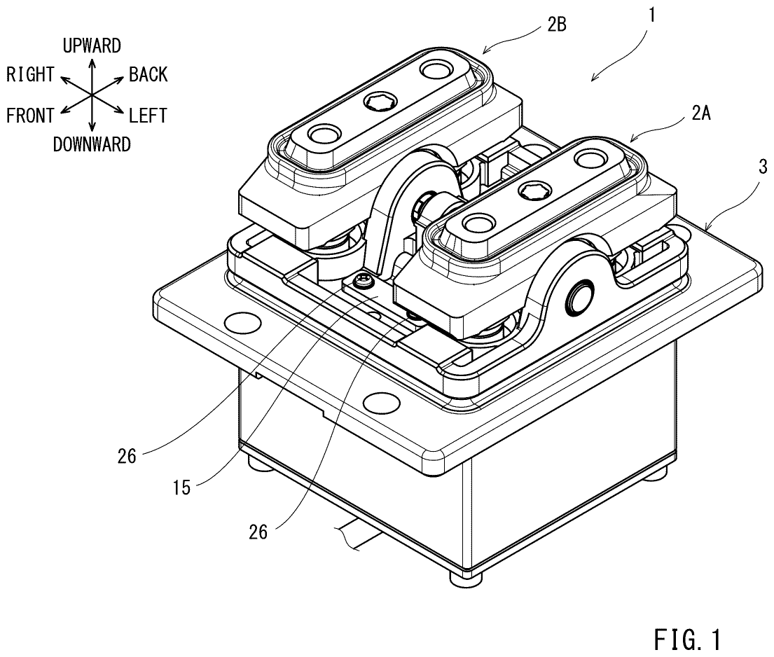

FIG. 1 shows an electrical operating device 1. For the sake of convenience, the description herein is given by using a front-back direction, a left-right direction, and an upward-downward direction shown in FIG. 1. The electrical operating device 1 is a device that outputs an electrical signal corresponding to an operating amount of an operating tool, such as a pedal or a lever. The use application of the electrical operating device 1 is not particularly limited. For example, the electrical operating device 1 is used in a construction machine such as a hydraulic excavator. For example, the electrical operating device 1 is used as a travel pedal device.

The electrical operating device 1 includes left operating equipment 2A, right operating equipment 2B, and a casing 3. Each of the left operating equipment 2A and the right operating equipment 2B is mounted to the casing 3. With the left operating equipment 2A, the drive direction and the speed of a left crawler are controllable. With the right operating equipment 2B, the drive direction and the speed of a right crawler are controllable. Pedals that are not shown are mounted to the left and right operating equipment 2A and 2B, respectively. Each of the left operating equipment 2A and the right operating equipment 2B can output an electrical signal in accordance with an operating amount of the corresponding pedal.

The left operating equipment 2A and the right operating equipment 2B are equivalent to each other. The left operating equipment 2A and the right operating equipment 2B are symmetrical in structure with respect to a plane that is located midway between the left operating equipment 2A and the right operating equipment 2B. In the description below, the left operating equipment 2A is mainly described, and the description of the right operating equipment 2B is omitted.

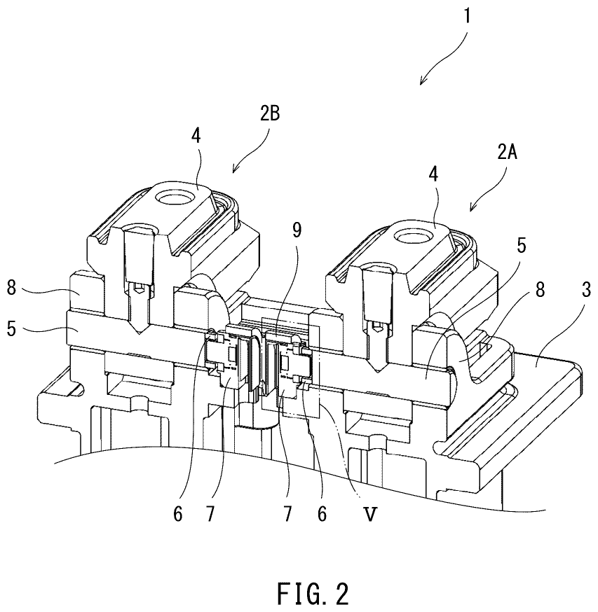

FIG. 2 shows a fragmentary sectional view of the electrical operating device 1. The left operating equipment 2A includes a cam 4, a cam shaft 5, a coupling 6, and a potentiometer 7. The casing 3 includes a cam support 8. The electrical operating device 1 further includes a potentiometer cover 9.

The cam shaft 5 is supported by the cam support 8. The cam shaft 5 is rotatable. That is, the cam shaft 5 is rotatably supported by the casing 3. The cam 4 is fixed to the cam shaft 5. Accordingly, the cam 4 is rotatable together with the cam shaft 5. The potentiometer 7 is mounted to the casing 3 by the potentiometer cover 9. The cam shaft 5 and the potentiometer 7 are connected to each other via the coupling 6.

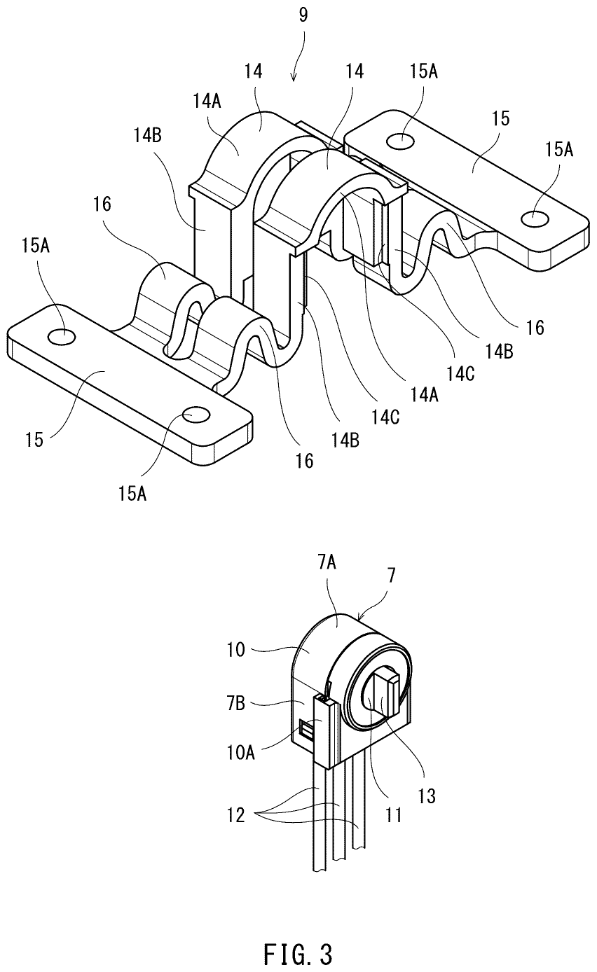

FIG. 3 shows the potentiometer 7 and the potentiometer cover 9. The potentiometer 7 includes a case 10, a shaft 11, and wiring 12. The shaft 11 is rotatable relative to the case 10. The shaft 11 includes a rotating protrusion 13. The potentiometer 7 includes projections 10A. The projections 10A project from the surface of the case 10. With the wiring 12, signals can be inputted to the potentiometer 7 from the outside and outputted from the potentiometer 7 to the outside. The potentiometer 7 can output the amount of rotation of the shaft 11 as an electrical signal.

The potentiometer cover 9 includes a pair of holders 14, a pair of mounting portions 15, and four urging portions 16. Each holder 14 is connected to each mounting portion 15 via urging portions 16. That is, the urging portions 16 by which one of the pair of holders 14 is connected to the mounting portions 15 are different from the urging portions 16 by which the other holder 14 is connected to the mounting portions 15.

In the potentiometer cover 9, the holders 14, the mounting portions 15, and the urging portions 16 are integrated together. In light of cost reduction, preferably, the potentiometer cover 9 is an integrally molded article. However, the potentiometer cover 9 is not limited to an integrally molded article. For example, separately prepared urging bodies may be used as the urging portions 16. The potentiometer cover 9 may be configured such that the holders 14 and the mounting portions 15 are connected to each other via such urging bodies.

Each holder 14 includes a top plate 14A, a pair of side plates 14B, and a pair of recesses 14C. The pair of side plates 14B face each other. The top plate 14A is positioned between the pair of side plates 14B, and the pair of side plates 14B extend from respective ends of the top plate 14A. The recesses 14C are recessed from the surface of the respective side plates 14B.

Each mounting portion 15 includes mounting holes 15A. As shown in FIG. 1, screws 26 are screwed into the respective mounting holes 15A, and thereby the potentiometer cover 9 is mounted to the casing 3. The mounting portions 15, which are mounted to the casing 3 with the screws 26, are merely one example. The mounting portions 15 are not particularly limited, so long as the mounting portions 15 enable the potentiometer cover 9 to be mounted to the casing 3. The mounting portions 15 may be mounted to the casing 3 not only with the screws 26, but also with other means.

The potentiometer 7 shown in FIG. 3 is held by one of the holders 14. When the potentiometer 7 is in the position of being held by the holder 14, a top surface 7A of the potentiometer 7 is in contact with the top plate 14A of the holder 14, and side surfaces 7B of the potentiometer 7 are in contact with the respective side plates 14B of the holder 14. The projections 10A of the potentiometer 7 are engaged with the respective recesses 14C of the holder 14. As a result of the engagement, the potentiometer 7 is positioned in relation to the holder 14 in the axial direction of the cam shaft 5. Instead of the projections 10A and the recesses 14C, the potentiometer 7 may include recesses, and each holder 14 may include projections. The top plate 14A of the holder 14 is elastically deformed, and thereby the potentiometer 7 is sandwiched between the pair of side plates 14B. As a result of the potentiometer 7 being sandwiched between the pair of side plates 14B, the potentiometer 7 is positioned in relation to the holder 14.

In FIG. 3, the potentiometer 7 of the left operating equipment 2A is shown, and the illustration of the potentiometer 7 of the right operating equipment 2B is omitted. In the same manner as the potentiometer 7 of the left operating equipment 2A is held by one of the holders 14, the potentiometer 7 of the right operating equipment 2B is held by the other holder 14 although it is not shown.

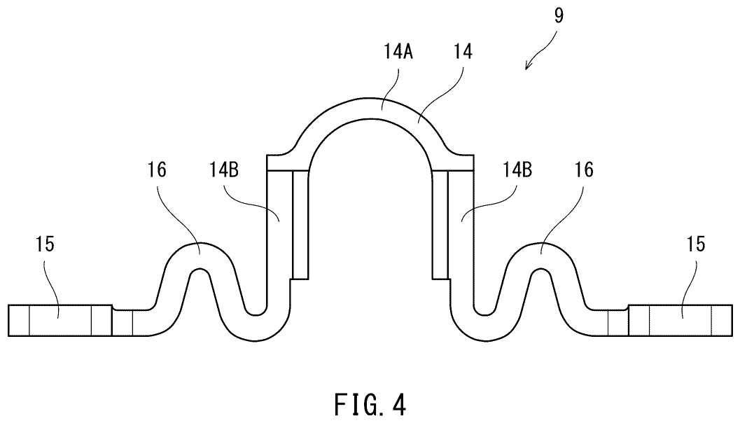

As shown in FIG. 4, each top plate 14A of the potentiometer cover 9 is bent. Accordingly, the top plate 14A is easily elastically deformed. In FIG. 4, the top plate 14A is bent such that it is arc-shaped. The bent shape of the top plate 14A is not limited to an arc shape. The bent shape of the top plate 14A is preferably such a shape that when the top plate 14A is elastically deformed, the potentiometer 7 can be sandwiched between the pair of side plates 14B.

Each urging portion 16 of the potentiometer cover 9 is bent. Accordingly, the urging portion 16 is easily elastically deformed. In FIG. 4, the urging portion 16 is bent such that it has an inverted U shape. The bent shape of the urging portion 16 is not particularly limited. The bent shape of the urging portion 16 may be any shape, so long as the urging portion 16 is elastically deformable when the position of the holder 14 in relation to the mounting portions 15 is changed.

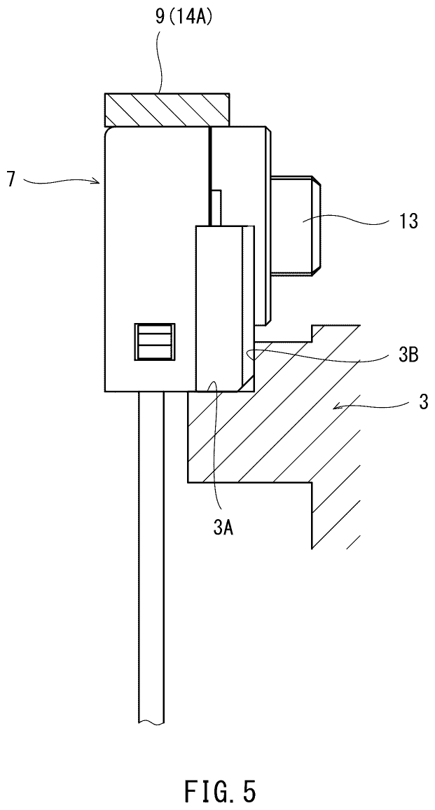

FIG. 5 shows a mounted state of the potentiometer 7 as indicated by reference sign V in FIG. 2. The potentiometer 7 is mounted to the casing 3 by the potentiometer cover 9. In FIG. 5, the illustration of the coupling 6 and the cam shaft 5, which are connected to the potentiometer 7, is omitted. Although not illustrated, the rotating protrusion 13 of the potentiometer 7 is engaged with the coupling 6, and thereby the potentiometer 7 and the coupling 6 are connected to each other.

The casing 3 includes a position reference surface 3A and a position reference surface 3B. As a result of the potentiometer cover 9 being mounted to the casing 3, the potentiometer 7 is in contact with the casing 3, and the potentiometer 7 is pressed against the casing 3. The potentiometer 7 is pressed against the position reference surface 3A by the top plate 14A of the potentiometer cover 9. The potentiometer 7 is pressed against the position reference surface 3B by the potentiometer cover 9 in such a manner that the projections 10A of the potentiometer 7 and the recesses 14C of the potentiometer cover 9 are engaged with each other (see FIG. 3).

The position reference surface 3A is a position reference surface for the potentiometer 7 in the upward-downward direction. The position reference surface 3B is a position reference surface for the potentiometer 7 in the axial direction of the cam shaft 5. As shown in FIG. 2, the cam shaft 5 and the potentiometer 7 are connected to each other via the coupling 6. With the coupling 6, a deviation between the axis of the cam shaft 5 and the axis of the potentiometer 7 is adjusted.

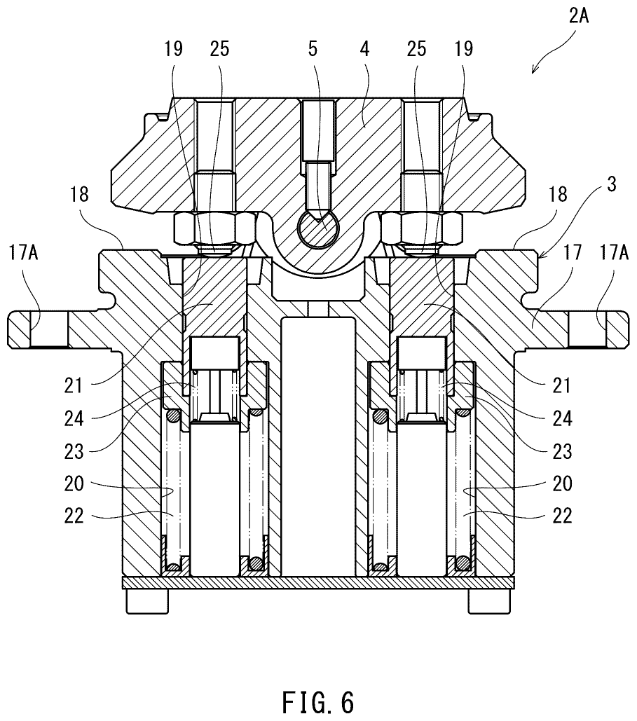

FIG. 6 shows a sectional view of the electrical operating device 1 of FIG. 1. FIG. 6 shows a sectional view of the left operating equipment 2A. The cam 4 is not tilted in the front-back direction. The cam 4 is in a neutral position. Also in the description below, the left operating equipment 2A is mainly described, and the description of the right operating equipment 2B is omitted.

The casing 3 includes a base 17. The base 17 is positioned below the cam 4. The base 17 is, for example, mounted to the floor of an operator's cab of a construction machine. Bolts are passed through through-holes 17A of the base 17, and are fixed to the floor. For the mounting of the left operating equipment 2A, the casing 3 includes a pair of stoppers 18, a pair of guide holes 19, and a pair of accommodating chambers 20. The pair of stoppers 18 are positioned such that they are spaced apart from each other in the front-back direction, with the cam shaft 5 positioned between them. The pair of guide holes 19 are positioned such that they are spaced apart from each other in the front-back direction, with the cam shaft 5 positioned between them. The accommodating chambers 20 are positioned below the respective guide holes 19. The guide holes 19 and the accommodating chambers 20 are positioned coaxially with each other. The guide holes 19 and the accommodating chambers 20 are in communication with each other.

The left operating equipment 2A includes a pair of push rods 21, a pair of springs 22, a pair of spring receivers 23, and a pair of damper springs 24. The push rods 21 are received in the respective guide holes 19. The push rods 21 are movable along the respective guide holes 19. The spring receivers 23 are accommodated in the respective accommodating chambers 20. The spring receivers 23 are movable along the respective accommodating chambers 20. The spring receivers 23 are urged by the respective springs 22 to the upper end of the respective accommodating chambers 20. The push rods 21 are supported by the respective spring receivers 23 from below. The damper springs 24 urge the respective push rods 21 toward the cam 4. The push rods 21 are in contact with respective pushers 25 of the cam 4.

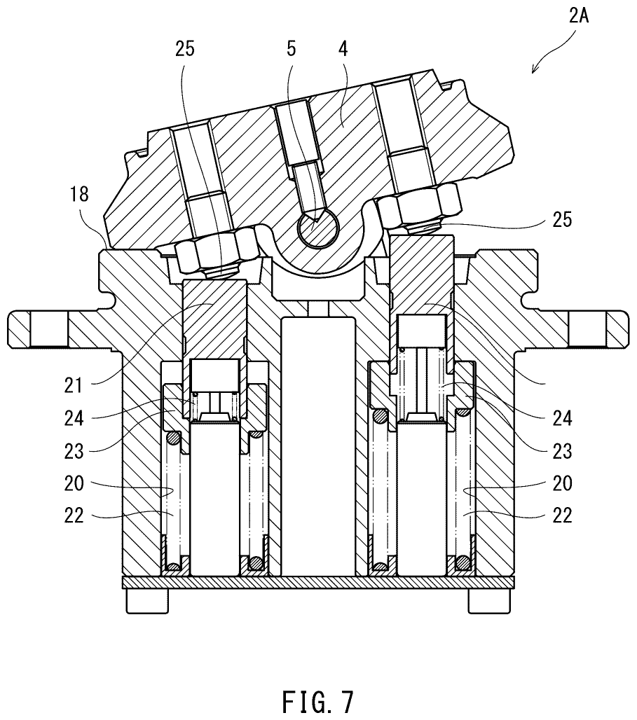

FIG. 7 shows a sectional view of the left operating equipment 2A when the cam 4 has fully rotated to the front side. The cam 4 is in contact with the front-side stopper 18. The front-side pusher 25 pushes down the push rod 21. The spring receiver 23 is pushed downward by the push rod 21 that has been pushed down. The spring receiver 23 is pushed downward against the urging force of the spring 22. The damper spring 24 is compressed by the push rod 21 that has been pushed down. Meanwhile, the back-side push rod 21 is pushed up by the damper spring 24. The back-side push rod 21 is in contact with the pusher 25 that has rotated upward.

In the electrical operating device 1, the pedal is mounted to each of the left operating equipment 2A and the right operating equipment 2B. A usage state shown in FIG. 6 is the state of the left operating equipment 2A when it is not operated by an operator. In this usage state, the potentiometer 7 is detecting a rotational angle of the cam shaft 5. Based on a detection signal from the potentiometer 7, the left crawler is in a non-driven state, i.e., a stopped state. The usage state shown in FIG. 6 is also the state of the right operating equipment 2B when it is not operated by the operator. In this usage state, the right crawler is in a non-driven state, i.e., a stopped state.

On the other hand, when the operator depresses the pedal to the front side, the cam 4 and the cam shaft 5 rotate counterclockwise. When the operator fully depresses the pedal to the front side, the cam 4 comes into contact with the stopper 18. The cam 4 and the cam shaft 5 fully rotate counterclockwise. Accordingly, the state of the left operating equipment 2A changes to a usage state shown in FIG. 7. In this usage state, the potentiometer 7 is detecting a rotational angle of the cam shaft 5. Based on a detection signal from the potentiometer 7, the left crawler is driven forward at a maximum speed.

In the electrical operating device 1, when the pedal is depressed to the front side, the crawler is driven forward. When the pedal is depressed to the back side, the crawler is driven backward. The speed of the crawler is controlled by changing a depression amount of the cam 4.

When the operator depresses both the left and right pedals in the same manner to the front side, the construction machine travels forward. When the operator depresses both the left and right pedals in the same manner to the back side, the construction machine travels backward. When the operator makes the left pedal depression amount and the right pedal depression amount different from each other, a speed difference occurs between the left crawler and the right crawler. Due to the speed difference, the construction machine makes a turn. By changing the speed difference, the turning radius of the construction machine is changed.

The electrical operating device 1 includes the potentiometer cover 9. The potentiometer cover 9 includes: the holders 14, which hold the respective potentiometers 7; the mounting portions 15 mounted to the casing 3; and the urging portions 16, which are located between the holders 14 and the mounting portions 15 and which cause the potentiometers 7 to be in contact with the casing 3. The electrical operating device 1 makes it possible to reduce the number of components for the mounting of the potentiometers 7.

In the potentiometer cover 9, each holder 14 holds the potentiometer 7. The potentiometer cover 9 is positioned in relation to the holder 14. As a result of the potentiometer cover 9 being mounted to the casing 3, the potentiometer 7 is mounted to the casing 3. The potentiometer cover 9 makes it possible to readily position the potentiometer 7 in relation to the casing 3.

The potentiometer cover 9 causes the potentiometer 7 to be in contact with the position reference surface 3A of the casing 3. As a result, the potentiometer 7 is positioned in the upward-downward direction. In light of this, it is preferable for the casing 3 to include the position reference surface 3A. The potentiometer cover 9 also causes the potentiometer 7 to be in contact with the position reference surface 3B of the casing 3. As a result, the potentiometer 7 is positioned in the axial direction of the cam shaft 5. In light of this, it is preferable for the casing 3 to include the position reference surface 3B.

As shown in FIG. 4, the sectional shape of each urging portion 16 is a bent shape on a plane oriented along a direction extending from the corresponding mounting portion 15 to the holder 14, the plane being parallel to the urging direction of the urging portion 16. The urging portion 16 having a bent sectional shape is easily elastically deformed in the urging direction.

The urging portion 16 having a bent sectional shape is excellent in terms of durability against the elastic deformation. In light of this, the sectional shape of the urging portion 16 is preferably a bent shape.

In the potentiometer cover 9, the shape of the urging portion 16 may be a plate shape extending between the mounting portion 15 and the holder 14. The shape of the urging portion 16 may be a bent plate shape. If the shape of the urging portion 16 is such a plate shape that the thickness thereof is less than the width thereof, the urging portion is easily elastically deformed in the urging direction. In light of this, preferably, the urging portion 16 has such a plate shape that the thickness thereof is less than the width thereof.

Although the urging portion 16 preferably has a sectional shape that is suitable for elastic deformation, the sectional shape of the urging portion 16 is not particularly limited. For example, the sectional shape of the urging portion 16 may be a corrugated shape including continuous bent shapes. The bent sectional shape of the urging portion 16 is not particularly limited. However, in light of durability, the bent sectional shape of the urging portion 16 is preferably a smoothly curved shape.

In the potentiometer cover 9 shown in FIG. 4, each urging portion 16 is inverted U-shaped. A sectional shape in a U shape is a simple shape. Therefore, the production of the potentiometer cover 9 is easy. In addition, the urging portion 16 thus configured has excellent durability. In light of these, the sectional shape of the urging portion 16 is preferably a U shape. The sectional shape of the urging portion 16 may be a corrugated shape.

As shown in FIG. 2, the electrical operating device 1 includes the left operating equipment 2A and the right operating equipment 2B. The cam shaft 5, the cam 4, and the potentiometer 7 in the left operating equipment 2A are a first cam shaft, a first cam, and a first potentiometer. The cam shaft 5, the cam 4, and the potentiometer 7 in the right operating equipment 2B are a second cam shaft, a second cam, and a second potentiometer. In the potentiometer cover 9, one of the holders 14 and one pair of urging portions 16 are a first holder and first urging portions, and the other holder 14 and the other pair of urging portions 16 are a second holder and second urging portions. The potentiometer cover 9 causes the potentiometer 7 of the left operating equipment 2A and the potentiometer 7 of the right operating equipment 2B to be in contact with the casing 3. The potentiometer 7 of the left operating equipment 2A and the potentiometer 7 of the right operating equipment 2B are mounted to the casing 3 by the potentiometer cover 9. The potentiometer cover 9 configured in this manner further contributes to reduction of the number of components of the electrical operating device 1 and reduction of assembly man-hours.

As shown in FIG. 2, in the electrical operating device 1, the potentiometer 7 of the left operating equipment 2A and the potentiometer 7 of the right operating equipment 2B are located between the cam 4 of the left operating equipment 2A and the cam 4 of the right operating equipment 2B. Since the pair of potentiometers 7 are located in this manner, the pair of potentiometers 7 can be readily mounted to the casing 3 by one potentiometer cover 9. Further, in the electrical operating device 1, the cam shaft 5 of the left operating equipment 2A and the cam shaft 5 of the right operating equipment 2B are located coaxially with each other.

Since the pair of cam shafts 5 are located coaxially with each other, the pair of potentiometers 7 can be more readily mounted to the casing 3 by the potentiometer cover 9.

In the description herein, an example has been described, in which the electrical operating device 1 is used as a travel pedal device of a construction machine. Alternatively, the electrical operating device 1 may be used as a pedal device that is not a travel pedal device. A lever to be hand-operated by an operator may be mounted to the electrical operating device 1, which then may be used as an electrical lever device. Further, both a pedal and a lever may be mounted to the electrical operating device 1, which then may be used as an electrical lever/pedal device.

The electrical operating device 1 is suitably applicable to a hydraulic circuit intended for operating a construction machine, such as a hydraulic excavator, a hydraulic crane, or a wheel loader. The electrical operating device 1 is applicable not only to construction machines, but also to other vehicles and machines.

The electrical operating device 1 includes the left operating equipment 2A and the right operating equipment 2B. Alternatively, the number of pieces of such operating equipment included in the electrical operating device 1 may be one. The potentiometer cover 9 includes the pair of holders 14. Alternatively, the number of holders 14 included in the potentiometer cover 9 may be one.

### Aspects of Disclosure

Each of the following aspects discloses a preferred embodiment.

### Aspect 1

An electrical operating device including: a casing; a cam shaft rotatably supported by the casing; a cam that rotates together with the cam shaft; a potentiometer that detects a rotational angle of the cam shaft; and a potentiometer cover including: a holder that holds the potentiometer; mounting portions mounted to the casing; and urging portions that are located between the holder and the mounting portions and that cause the potentiometer to be in contact with the casing.

According to the above configuration, the potentiometer cover includes: the holder that holds the potentiometer; the mounting portions mounted to the casing; and the urging portions that cause the potentiometer to be in contact with the casing. This configuration makes it possible to reduce the number of components.

### Aspect 2

The electrical operating device according to aspect 1, wherein the potentiometer is in contact with a position reference surface of the casing.

According to the above configuration, the potentiometer is in contact with the reference surface of the casing. As a result, the potentiometer can be positioned with respect to the casing.

### Aspect 3

The electrical operating device according to aspect 1 or 2, wherein a sectional shape of each urging portion is a bent shape on a plane oriented along a direction extending from the corresponding mounting portion to the holder, the plane being parallel to an urging direction of the urging portion.

According to the above configuration, since each urging portion has a bent sectional shape, the urging portion is easily elastically deformed in the urging direction, and has excellent durability against the elastic deformation.

### Aspect 4

The electrical operating device according to aspect 3, wherein the sectional shape is a U shape.

According to the above configuration, since the sectional shape of each urging portion is a U shape, the production of the potentiometer cover is easy, and the urging portion has excellent durability.

### Aspect 5

The electrical operating device according to aspect 3 or 4, wherein the sectional shape is a corrugated shape.

According to the above configuration, since each urging portion has a corrugated sectional shape, the urging portion is easily elastically deformed, and has excellent durability against the elastic deformation.

### Aspect 6

The electrical operating device according to any one of aspects 1 to 5, wherein the cam shaft, the cam, the potentiometer, the holder, and the urging portions are a first cam shaft, a first cam, a first potentiometer, a first holder, and first urging portions, the electrical operating device further including: a second cam shaft that is rotatably supported by the casing; a second cam that rotates together with the second cam shaft; and a second potentiometer that detects a rotational angle of the second cam shaft, wherein the potentiometer cover includes: a second holder that holds the second potentiometer; and second urging portions that are located between the second holder and the mounting portions and that cause the second potentiometer to be in contact with the casing.

According to the above configuration, the one potentiometer cover causes each of the pair of potentiometers to be in contact with the casing 3. The potentiometer cover configured in this manner further contributes to reduction of the number of components and reduction of assembly man-hours.

### Aspect 7

The electrical operating device according to aspect 6, wherein the first potentiometer and the second potentiometer are positioned between the first cam and the second cam.

According to the above configuration, the pair of potentiometers can be located in proximity to each other. As a result, the pair of potentiometers can be readily mounted to the casing by one potentiometer cover.

### Industrial Applicability

The above-described electrical operating device is widely applicable not only to construction machines but also to the operation of various machines.

### Reference Signs List

1 . . . electrical operating device
2A . . . left operating equipment
2B . . . right operating equipment
3 . . . casing
4 . . . cam (first cam, second cam)
5 . . . cam shaft (first cam shaft, second cam shaft)
7 . . . potentiometer (first potentiometer, second potentiometer)
9 . . . potentiometer cover
14 . . . holder (first holder, second holder)
15 . . . mounting portion
16 . . . urging portion (first urging portion, second urging portion)

1. An electrical operating device comprising:
a casing;
a cam shaft rotatably supported by the casing;
a cam that rotates together with the cam shaft;
a potentiometer that detects a rotational angle of the cam shaft; and
a potentiometer cover including:
a holder that holds the potentiometer;
mounting portions mounted to the casing; and
urging portions that are located between the holder and the mounting portions and that cause the potentiometer to be in contact with the casing.

2. The electrical operating device according to claim 1, wherein the potentiometer is in contact with a position reference surface of the casing.

3. The electrical operating device according to claim 1, wherein
a sectional shape of each urging portion is a bent shape on a plane oriented along a direction extending from the corresponding mounting portion to the holder, the plane being parallel to an urging direction of the urging portion.

4. The electrical operating device according to claim 3, wherein
the sectional shape is a U shape.

5. The electrical operating device according to claim 3, wherein
the sectional shape is a corrugated shape.

6. The electrical operating device according to claim 1, wherein
the cam shaft, the cam, the potentiometer, the holder, and the urging portions are a first cam shaft, a first cam, a first potentiometer, a first holder, and first urging portions,
the electrical operating device further comprising:
a second cam shaft that is rotatably supported by the casing;
a second cam that rotates together with the second cam shaft; and
a second potentiometer that detects a rotational angle of the second cam shaft, wherein
the potentiometer cover includes:
a second holder that holds the second potentiometer; and
second urging portions that are located between the second holder and the mounting portions and that cause the second potentiometer to be in contact with the casing.

7. The electrical operating device according to claim 6, wherein
the first potentiometer and the second potentiometer are positioned between the first cam and the second cam.

8. The electrical operating device according to claim 2, wherein
a sectional shape of each urging portion is a bent shape on a plane oriented along a direction extending from the corresponding mounting portion to the holder, the plane being parallel to an urging direction of the urging portion.

9. The electrical operating device according to claim 8, wherein
the sectional shape is a U shape.

10. The electrical operating device according to claim 8, wherein
the sectional shape is a corrugated shape.

11. The electrical operating device according to claim 2, wherein
the cam shaft, the cam, the potentiometer, the holder, and the urging portions are a first cam shaft, a first cam, a first potentiometer, a first holder, and first urging portions,
the electrical operating device further comprising:
a second cam shaft that is rotatably supported by the casing;
a second cam that rotates together with the second cam shaft; and
a second potentiometer that detects a rotational angle of the second cam shaft, wherein
the potentiometer cover includes:
a second holder that holds the second potentiometer; and
second urging portions that are located between the second holder and the mounting portions and that cause the second potentiometer to be in contact with the casing.

12. The electrical operating device according to claim 11, wherein
the first potentiometer and the second potentiometer are positioned between the first cam and the second cam.
